(19) United States
(12) Patent Application Publication
(10) Pub. No.: US 2014/0261746 A1
(43) Pub. Date: Sep. 18, 2014

(54) Methods And Systems For Improving The Operation Of Transmissions For Motor Vehicles

(71) Applicant: Gilbert W. Younger, EI Monte, CA (US)

(72) Inventor: Gilbert W. Younger, EI Monte, CA (US)

(21) Appl. No.: 14/023,687

(22) Filed: Sep. 11, 2013

Related U.S. Application Data
(60) Provisional application No. 61/851,763, filed on Mar. 13, 2013.

(51) Int. Cl. F16K 51/00

(52) U.S. Cl. CPC F16K 51/00
USPC 137/15.18; 137/485

(57) ABSTRACT

A pressure regulator valve to replace the pressure regulator valve of a “factory installed” automotive transmission has a pressure regulator balance circuit provided internally within a first portion of the pressure regulator valve. The pressure regulator valve also has a decrease exhaust circuit provided internally within a second portion of the pressure regulator valve. One or more outer lands of the pressure regulator valve has a width greater than that of the outer land of the “factory installed” pressure regulator valve, and the pressure regulator valve has an inner land having a greater width than that of the inner land of the “factory installed” pressure regulator valve. The pressure regulator valve provides efficient pump control while providing support and stability greater than that provided by the “factory installed” pressure regulator valve.

The present patent application claims the benefit of U.S. Provisional Patent Application Ser. No. 61/851,763 filed on Mar. 13, 2013, pursuant to 35 U.S.C. 119 (e).

### BACKGROUND OF THE INVENTION

The methods and systems of the present invention are directed to the modification and improvement of transmissions for automotive vehicles, more commonly referred to as “factory installed” transmissions, installed in automotive vehicles by an original motor vehicle manufacturer. The present invention is more particularly directed to improvements to the “factory installed” transmissions for General Motors Corporation (GM) vehicles equipped with automatic transmissions identified as 6L80E, 6L85E, 6L90E, 5L40E, 4L60E, 4L65E, and 4L70E.

The present inventor is the inventor identified in the following United States patents and published patent application, the disclosures of which are expressly incorporated by reference into the present patent application: U.S. Pat. No. 4,449,426, issued May 26, 1984; U.S. Pat. No. 4,711,140, issued Dec. 8, 1987; U.S. Pat. No. 4,790,938, issued Dec. 13, 1988; U.S. Pat. No. 5,253,549; issued Oct. 19, 1993; U.S. Pat. No. 5,540,628, issued Jul. 30, 1996; U.S. Pat. No. 5,624,342; issued Apr. 29, 1997; U.S. Pat. No. 5,730,685, issued Mar. 24, 1998; U.S. Pat. No. 5,743,823, issued Apr. 28, 1998; U.S. Pat. No. 5,768,953, issued Jun. 23, 1998; U.S. Pat. No. 5,820,507, issued Oct. 7, 1998; U.S. Pat. No. 5,967,928, issued Oct. 19, 1999; U.S. Pat. No. 6,099,429, issued Aug. 8, 2000; U.S. Pat. No. 6,117,047, issued Sep. 12, 2000; U.S. Pat. No. 6,287,231, issued Sep. 11, 2001; U.S. Pat. No. 6,390,944, issued May 21, 2002; U.S. Pat. No. 6,565,472, issued May 20, 2003; U.S. Pat. No. 6,699,157, issued Mar. 2, 2004; U.S. Pat. No. 6,729,989, issued May 4, 2004; U.S. Pat. No. 6,814,680, issued Nov. 9, 2004; U.S. Pat. No. 6,871,397, issued Mar. 29, 2005; U.S. Pat. No. 6,913,554, issued Jul. 5, 2005; U.S. Pat. No. 6,964,628, issued Nov. 15, 2005; U.S. Pat. No. 7,128,679, issued Oct. 31, 2006; U.S. Pat. No. 7,331,893, issued Feb. 19, 2008; and US2013/0037134, published on Feb. 14, 2013.

The basic principles of operation of the “factory installed” automotive transmission for the 6L80E and the additional aforementioned GM automotive transmissions, are well known to those skilled in the automotive transmission art. Attention is respectfully invited to the operations manual and text entitled HYDRA-MATIC, 6 Speed, RWD, TECHNICIAN'S GUIDE, 2005, published by General Motors Corporation (GM publication), said publication describing in detail the operation of the “factory installed” 6L80E General Motors automotive transmission, including a description of the structure, the hydraulic circuitry, and the interrelationship between the structure and the hydraulic circuitry and fluid flow during normal operation of this “factory installed” transmission. The disclosure of the aforementioned GM publication in its entirety is expressly incorporated by reference into the disclosure of the present patent application as disclosing and illustrating background material known to those of ordinary skill in the automotive transmission art.

It is the primary object of the present invention to modify the aforementioned “factory installed” automotive transmissions, including the GM 6L80E, to improve the overall operation and efficiency of these “factory installed” automotive transmissions.

The present inventor has recognized that the main pressure regulator bore in the aforementioned “factory installed” GM automotive transmissions can suffer damage from use over time, resulting in wear causing a variety of operational failures including loss of pump pressure control, converter drain-back, delayed (or no) engagement, pump noise and catastrophic drum breakage. Known solutions to these conditions are expensive and require either a complete replacement of components, or purchasing specialized and expensive boring tools and additional holding fixtures to re-bore half of the fluid pump and thereafter purchasing and installing oversized valves.

In accordance with the methods and systems of the present invention, the “factory installed” 6L80E, as well as the additional “factory installed” automotive transmissions identified above, are modified to prevent the aforementioned damage and to increase the efficiency and overall useful operating life of the automotive transmission. As will be discussed herein, the modifications include relocating the pressure regulator balance circuit internally within a first portion of the pressure regulator valve and relocating the decrease exhaust circuit internally within a second portion of the pressure regulator valve, thereby permitting an increase in the width of the inner valve land, the outer valve land, or both. The increase in width of the land(s) of the pressure regulator valve provide increased surface areas of the land(s) which contact the valve bore, thereby more evenly distributing wear over a greater area along the bore resulting in less concentrated wear of the bore which reduces the possibility of leaks, provides a more firm seal between the lands and the bores, and increases the operating life of the pressure regulator valve and circuit. These modifications to the “factory installed” transmission results in a more robust valve system that restores pump control without incurring the costly expense of new replacement parts, or the costly repair of re-boring the fluid pump and thereafter installing oversized valves.

Other advantages of the modifications to the “factory installed” automotive transmissions in accordance with the present invention will become apparent to those skilled in the automotive transmission art based upon the following detailed description of the invention in conjunction with the drawings.

### SUMMARY OF THE INVENTION

The present invention provides methods and systems for modifying the hydraulic circuitry of “factory installed” automotive transmissions, and in particular the automotive transmissions designated by 6L80E, 6L85E, 6L90E, 5L40E, 4L60E, 4L65E, and 4L70E, installed in automotive vehicles manufactured by General Motors Corporation of Detroit, Mich.

In accordance with a first aspect of the present invention, the hydraulic circuitry of the aforementioned “factory installed” automotive automatic transmissions are modified such that the pressure regulator balance circuit is provided internally within a first portion of the pressure regulator valve.

In a further aspect of the present invention, the hydraulic circuitry of the “factory installed” transmissions are modified such that the decrease exhaust circuit is provided internally within a second portion of the pressure regulator valve.

By relocating the pressure regulator balance circuit and/or the decrease exhaust circuit internally with the valve, the total width of the inner land(s), the outer land, or both, of the pressure regulator valve can be increased. The increase in the width of either or both of the inner and outer lands increases the surface area in contact with the valve bore, thereby more evenly distributing wear along the inner surface of the bore in which the pressure regulator valve moves. This, in turn, provides a more firm seal between the valve and the bore, decreasing the possibility of leaks and increasing the useful operating life of the pressure regulator valve and the pressure regulator circuit.

Each of the aforementioned modifications, both individually and collectively, improves the “factory installed” automotive transmission by avoiding damage and failures resulting over time during operation of the “factory installed” transmission, and avoiding either a complete replacement of a portion of the “factory installed” fluid pump, or a repair procedure involving use of specialized boring tools and additional holding fixtures to re-bore a portion of the fluid pump and thereafter installing oversized valves to correct a failure of the “factory installed” transmission.

The modifications of the “factory installed” automotive transmission in accordance with the present invention extend the useful operating life of the transmission, increase the efficiency of operation of the transmission, and avoid costly and unnecessary replacements and repairs to correct the failures of the original “factory installed” automotive transmission.

### BRIEF DESCRIPTION OF THE DRAWINGS

FIG. 1 of the drawing schematically illustrates the hydraulic pressure regulator circuit of a “factory installed” 6L80E automotive transmission installed in automotive vehicles manufactured by General Motors Corporation;

FIG. 2 illustrates, in greater detail, the pressure regulator valve of the “factory installed” pressure regulator circuit illustrated by FIG. 1 of the drawing;

FIG. 3 illustrates a modified pressure regulator valve in accordance with the present invention; and

FIG. 4 illustrates the modified pressure regulator valve illustrated by FIG. 3 within the bore of the pressure regulator circuit illustrated by FIG. 1 of the drawing.

### DETAILED DESCRIPTION OF THE BEST MODES FOR CARRYING OUT THE INVENTION

FIGS. 1-3 illustrate the hydraulic circuitry of a known “factory installed” automotive transmissions designated as 6L80E, 6L85E, 6L90E, 5L40E, 4L60E, 4L65E, and 4L70E, installed in motor vehicles manufactured by General Motors Corporation.

FIG. 1 illustrates the pressure regulator circuit of the aforementioned “factory installed” automotive transmissions. A pressure regulator valve designated by reference numeral 2 is moveable within a bore designated by reference numeral 4, and a spring designated by reference numeral 6 exerts a resilient force on a spring seat designated by reference numeral 8 on the pressure regulator valve. A fluid pump designated by reference numeral 10 is in fluid communication with the pressure regulator valve through a line designated by reference numeral 12. A decrease exhaust circuit is provided by a line 14 also in fluid communication with the pressure regulator valve. A line 16 provides fluid communication between the pressure regulator valve and a regulator balance circuit. A line designated by reference numeral 18 connects the pressure regulator valve 2 to a converter feed limit valve designated by reference numeral 20.

FIG. 2 illustrates the pressure regulator valve 2 and the bore 4, as illustrated in FIG. 1, and shown in greater detail. The reference numerals used in FIG. 2 correspond to the reference numerals used in FIG. 1.

Additional information and description relating to the hydraulic circuitry, components, and operation of the aforementioned “factory installed” automotive transmissions, which will be understood by persons skilled in the relevant art, is available from the aforementioned publication entitled HYDRA-MATIC, 6 Speed RWD, TECHNICIAN'S GUIDE, 2005, General Motors Corporation, which has been expressly incorporated by reference into the present Specification.

The aforementioned “factory installed” automotive transmissions, over time, are subject to wear, resulting in potential failures such as loss of pump pressure control, converter drain-back, delayed engagement or no engagement, pump noise, and drum breakage. As discussed herein, correction of these failures requires either the purchase of specialized tools or the replacement of new components requiring a labor intensive installation/repair.

In accordance with the present invention, the aforementioned disadvantages currently required to correct a failure of the “factory installed” automotive transmission are avoided by replacing the pressure regulator valve of the “factory installed” automotive transmission with a new pressure regulator valve to be described as follows.

FIG. 3 illustrates the new pressure regulator valve, generally designated by reference numeral 22, in accordance with the present invention. The pressure regulator valve includes two outer lands designated by reference numeral 23 and 24 separated by a circumferential groove 25. The outer lands have a combined width greater than the width of the “factory installed” pressure regulator valve (the width of the “factory installed” outer land of the pressure regulator valve is 0.2 inches, while the wider outer lands 23 and 24 of the new pressure regulator valve have a combined width in the range of 0.25 inches-0.75 inches, preferably 0.61 inches with the smaller outer land 23 having a width of 0.23 inches and the larger outer land 24 having a width of 0.38 inches). Similarly, the inner land of the new pressure regulator valve designated by reference numeral 26 is wider than the inner land of the “factory installed” pressure regulator valve (the inner land of the “factory installed” pressure regulator valve is 0.2 inches, while the wider inner land 26 of the new pressure regulator valve is in the range of 0.25 inches-0.75 inches, preferably 0.53 inches).

Still referring to FIG. 3 of the drawing, the line 14, providing the decrease exhaust circuit coupling the “factory installed” pressure regulator valve in fluid communication with the pump 10 (see FIGS. 1 and 2 of the drawing), has been replaced by a new decrease exhaust circuit provided by a port 28 in the pressure regulator valve 22 in fluid communication with a channel 30 defined internally within a portion of the pressure regulator valve 22. The port 28 is defined in the circumferential groove 25 disposed between the two outer lands 23 and 24.

Similarly, the pressure regulator balance circuit of the “factory installed” automotive transmission, illustrated by line 16 in FIGS. 1-2 of the drawing, has been replaced by a new pressure balance circuit provided by a port 32 in the pressure regulator valve 22, and a channel 34 defined internally within a portion of the pressure regulator valve 22 in fluid communication with the port 32.

FIG. 4 illustrates the new (replacement) pressure regulator valve 22 shown in FIG. 3 in its operating position in which it is reciprocatingly moveable within a bore 36, and a spring 38 exerting a resilient force on a spring seat 40 of the pressure regulator valve 22.

The pressure regulator valve, in accordance with the present invention, results in numerous advantages over the pressure regulator valve of the “factory installed” automotive transmission. By relocating the pressure regulator balance circuit internally within a portion of the pressure regulator valve (the port 32 and the internal channel 34 illustrated by FIG. 3), the width of the inner land 26 can be increased to provide both additional support for the pressure regulator valve and to provide a more positive seal between the pressure regulator valve and the bore in which it reciprocates. The increased surface area of the inner land more evenly distributes wear along the bore 36, thereby diminishing the possibility of leaks and thus extending the useful operating life of the pressure regulator valve. Additionally, by providing the pressure regulator balance circuit internally within a portion of the pressure regulator valve, a more reliable balance circuit operation is achieved.

Similarly, by providing the decrease exhaust circuit internally within a portion of the pressure regulator valve 22 (the port 28 and the internal channel 30 illustrated by FIG. 3), the width of the two outer lands 23 and 24 can be increased to provide additional support for the valve 22 and shifting movement of the valve onto unworn areas of the bore thereby stabilizing the entire pressure regulator valve. Additionally, the increased surface area of the outer land more evenly distributes wear along the bore and provides a more firm seal between the lands and the bore, thereby diminishing the possibility of leaks and further extending the useful operating life of the pressure regulator valve.

Providing the decrease exhaust circuit internally within a portion of the pressure regulator valve 22, as well as providing the pressure regulator balance circuit internally within a different portion of the pressure regulator valve 22, and increasing the width of the inner and outer lands of the valve, results in an efficient valve system that maintains pump control, without the expense of costly replacement parts or a labor intensive repair to correct a failure of the “factory installed” transmission.

The pressure regulator valve in accordance with the present invention results in efficient, reliable and stable pump control, thereby increasing the useful operating life of the pressure regulator circuit of the aforementioned automotive transmissions.

Although the preferred embodiment of the invention discussed herein discloses a pressure regulator valve having two outer lands 23 and 24, it is within the scope of the present invention to provide a pressure regulator valve with only a single outer land having a width greater than the outer land of the factory installed transmission.

Other advantages and modifications to the improved pressure regulator valve within the scope of the present invention will become apparent to those skilled in the automotive transmission art. Accordingly, the description of the preferred embodiment of the invention herein is illustrative only, and not restrictive of the scope of the invention, that scope being defined by the following claims and all equivalents thereto.

1. A pressure regulator valve for an automotive transmission, said pressure regulator valve adapted to be coupled to a pressure regulator balance circuit in fluid communication therewith, said pressure regulator valve comprising:
a valve body reciprocatingly moveable within a bore, and
a first channel defined internally within a first portion of the valve body in fluid communication with the pressure regulator balance circuit.

2. The pressure regulator valve as claimed in claim 1, further including a first port defined in said first portion of valve body and in fluid communication with said first channel defined internally within said first portion of said valve body.

3. The pressure regulator valve as claimed in claim 1, further including an inner land, said inner land having a width in the range of between 0.25-0.75 inches.

4. The pressure regulator valve as claimed in claim 1, further including one or more outer lands, the total width of said one or more outer lands being in the range of between 0.25-0.75 inches.

5. The pressure regulator valve as claimed in claim 1, said pressure regulator valve being adapted to be coupled in fluid communication with a decrease exhaust circuit, said pressure regulator valve further including a second channel defined internally within a second portion of said valve body, said second channel being in fluid communication with said decrease exhaust circuit.

6. The pressure regulator valve as claimed in claim 5, further including a second port defined in said second portion of said valve body, said second port being in fluid communication with said second channel defined internally within said second portion of said valve body.

7. A pressure regulator valve for an automotive transmission, said pressure regulator valve adapted to be in fluid communication with a decrease exhaust circuit, said pressure regulator valve comprising:
a valve body reciprocatingly moveable within a bore, and
a channel defined internally within a portion of the valve body, said channel being in fluid communication with said decrease exhaust circuit.

8. The pressure regulator valve as claimed in claim 7, wherein a port is defined in said portion of said valve body, said port being in fluid communication with said channel defined internally within said portion of said valve body.

9. The pressure regulator valve as claimed in claim 7, further including one or more outer lands, the total width of said one or more outer lands being in the range of between 0.25-0.75 inches.

10. The pressure regulator valve as claimed in claim 7, further including an inner land, said inner land having a width in the range of between 0.25-0.75 inches.

11. A method of modifying a “factory installed” automotive transmission, said automotive transmission having a pressure regulator valve in fluid communication with a pressure regulator balance circuit, said method comprising the steps of:
replacing said “factory installed” pressure regulator valve with a replacement pressure regulator valve; and
defining a first channel internally within a first portion of said replacement pressure regulator valve such that said first channel is in fluid communication with the pressure regulator balance circuit of said “factory installed” automotive transmission.

12. The method as claimed in claim 11, further including the step of:
defining a first port in said first portion of said replacement pressure regulator valve such that said first port is in fluid communication with said first channel defined internally within said first portion of said replacement pressure regulator valve.

13. The method as claimed in claim 11, further including the step of providing said replacement pressure regulator valve with one or more outer lands, the total width of said one or more outer lands being in the range of between 0.25-0.75 inches.

14. The method as claimed in claim 11, further including the step of providing said replacement pressure regulator valve with an inner land, said inner land having a width in the range of between 0.25-0.75 inches.

15. The method as claimed in claim 11, further including the step of defining a second channel internally within a second portion of said replacement pressure regulator valve such that said second channel is in fluid communication with a decrease exhaust circuit of said “factory installed” automotive transmission.

16. The method as claimed in claim 15, further including the step of defining a second port in said second portion of said replacement pressure regulator valve such that said second port is in fluid communication with said second channel internally defined in said second portion of said replacement pressure regulator valve.

17. The method as claimed in claim 16, further including the step of providing said replacement pressure regulator valve with one or more outer lands, the total width of said one or more outer lands being in the range of between 0.25-0.75 inches.

18. The method as claimed in claim 17, further including the step of providing said replacement pressure regulator valve with an inner land, said inner land having a width in the range of between 0.25-0.75 inches.

19. The pressure regulator valve as claimed in claim 5, further including one or more outer lands, the total width of said one or more outer lands being in the range of between 0.25-0.75 inches.

20. The pressure regulator valve as claimed in claim 5, further including an inner land, said inner land having a width within the range of between 0.25-0.75 inches.

21. The pressure regulator valve as claimed in claim 1, further including two outer lands separated by a circumferential groove.

22. The pressure regulator valve as claimed in claim 7, further including two outer lands separated by a circumferential groove.
